(19) United States
(12) Patent Application Publication
(10) Pub. No.: US 2017/0080448 A1
(43) Pub. Date: Mar. 23, 2017

(54) Ultrasonic Spray Coating Assembly

(71) Applicant: Ultrasonic Systems, Inc., Haverhill, MA (US)

(72) Inventors: Stuart J. Erickson, Marblehead, MA (US); Drew D. Erickson, Newbury, MA (US)

(21) Appl. No.: 15/267,513

(22) Filed: Sep. 16, 2016

Related U.S. Application Data
(60) Provisional application No. 62/221,925, filed on Sep. 22, 2015.
(60) Provisional application No. 62/247,407, filed on Oct. 28, 2015.

(51) Int. Cl. B05B 17/06

(52) U.S. Cl. CPC B05B 17/06

(57) ABSTRACT

Disclosed is an ultrasonic spray coating system wherein (1) the surface of the feed blade of the ultrasonic spray head has been modified to add a series shallow channels to redirect the ultrasonic surface wave system that exists on the surface; (2) the internal passageway of the liquid applicator has been modified to add a series of channels to uniformly feed the liquid from the liquid applicator to the spray-forming tip; (3) a positive displacement pump is utilized to deliver the liquid to the spray head at a precise flow rate independent of the associated resistances of the liquid delivery system components; and (4) the gas entrainment system has been improved so as to expand the ultrasonically produced spray uniformly and without pulsations.

### CROSS-REFERENCE TO RELATED APPLICATIONS

This application claims domestic priority to commonly owned, copending U.S. Provisional Patent Application No. 62/221,925, filed Sep. 22, 2015 and U.S. Provisional Patent Application No. 62/247,407, filed Oct. 28, 2015, the disclosures of which are hereby incorporated herein by reference.

### FIELD OF THE INVENTION

The present invention provides an ultrasonic spray assembly that represents an improvement over prior art spray devices, in which the coating pattern width, coating deposition uniformity, and spray stability are greatly improved.

### BACKGROUND OF THE INVENTION

There is an increasing need in industry to apply coatings to substrates in very thin, uniform layers at high production rates, such as the application of anti-reflective coatings to touch panel displays, lenses for LED lighting and solar panel cover glass. For example a typical coating deposition requirement is 0.0015 ml of liquid coating per square centimeter, which translates to a wet film thickness of 15 μm.

Current techniques for the application of thin coatings include spin coaters, slot-die coaters, spray nozzles and ultrasonic spray heads.

Spin coating involves spinning the substrate at a high speed and applying the coating to the rotating substrate. The coating forms a thin film on the surface as it is “spun off” the substrate due to the centrifugal forces from the high-speed rotation. The coating thickness is inversely proportional to the rotation speed of the substrate and the length of time that it is rotated. Spin coating techniques produce a very thin and uniform coating. However, the process is inherently slow because the substrates need to be processed one at a time. Additionally, over 90% of the coating liquid is wasted during the spin coating process. Therefore the spin coating method is not suited to high volume production due to the time required to achieve the thin coating and the waste of coating liquid.

Slot-die coating systems consist of a long precision machined device with an output orifice in the shape of a slot. The liquid is forced through this slot as the mechanism moves over the substrate to be coated or the substrate moves under the slot mechanism. The coating thickness is proportional to the flow rate of the liquid and the relative speed between the substrate and the slot mechanism. Slot-die coating systems require that the substrate be perfectly flat so they cannot be used if the substrate is curved, as is the case for lenses, or if the substrate is not perfectly flat, as is the case with solar panel cover glass.

An array of stationary spray nozzles mounted over a moving conveyor is another method of applying coatings to substrates. The coating is applied to the substrates as they pass beneath the spray nozzles. The coating thickness is proportional for the coating flow rate and inversely proportional to the conveyor speed. Spray nozzles produce a conical spray pattern and hence a parabolic coating distribution on the substrate depositing more coating at the center of the pattern and less at the edges, thus producing a non-uniform coating deposition on the substrates. Thus, stationary spray nozzles are not suitable for the application of thin, uniform coatings.

The use of a traversing ultrasonic spray head to achieve thin, uniform coating layers has been successful - within certain limits. This technique involves using an ultrasonic spray head that traverses and sprays the coating over moving substrates as they pass below on a conveyor. The coating thickness is proportional to the liquid flow rate and the traversing speed of the spray head. The motion of the traversing head is synchronized with the conveyor speed to achieve a uniform coating deposition on the substrates. However, the gas director used by ultrasonic spray heads to expand the spray pattern tends to generate a small “pulse” in the spray at a certain frequency. This pulsing of the spray translates to a slight coating thickness variation directly proportional to the pulse frequency of the spray.

In summary, although spin coating provides excellent coating results it is not suitable for high volume production; the slot-die coating techniques are only suitable for perfectly flat substrates; and stationary spray nozzles do not produce a uniform coating deposition or a thin coating layer.

### SUMMARY OF THE INVENTION

The present invention provides an ultrasonic spray coating assembly that represents an improvement over the ultrasonic spray systems described in U.S. Patent Pub. No. 2013-0264397, and U.S. Pat. Nos. 5,409,163, 5,540,384, 5,582,348 and 5,622,752, the disclosures of which are hereby incorporated herein by reference. The ultrasonic spray coating system of the present invention can be used in the methods taught in these patent documents, and can also be used as described herein.

The present invention is an ultrasonic spray coating assembly comprising an ultrasonic converter with spray head with a spray forming tip, a liquid applicator in close proximity to the spray forming tip, support brackets, an improved gas entrainment mechanism a positive displacement liquid delivery mechanism and an ultrasonic power generator.

This invention preferably comprises an ultrasonic spray coating assembly with a spray forming tip, a liquid applicator and an improved gas entrainment system. In the preferred embodiment, the system is capable of spraying liquids onto substrates in a wide, uniform rectilinear pattern at a width proportional to the distance between the spray forming tip and the substrate.

The present invention achieves the following benefits over the systems of prior art:
1) Produces a stable spray without pulsing; and
2) Produces a more uniform coating distribution on the substrate

The following improvements have been made to the prior art ultrasonic spray coating system:
1) The gas entrainment system has been redesigned to become a “gas applicator” in which the gas is forced through a precision machined applicator with a curved slot as the output orifice.
2) The gas flows out of the orifice at a controlled velocity in an expanding fan pattern. This directed air stream is impinged on to the spray forming tip of the ultrasonic spray coating assembly. The directed air stream is then re-directed as it impinges on to the spray forming tip. The resulting air stream entrains the ultrasonically produced spray and expands the spray width without creating pulsations.

### BRIEF DESCRIPTION OF THE DRAWINGS

FIG. 1 illustrates the ultrasonic spray coating system including the major components.

FIG. 2 illustrates the spray forming head part of the ultrasonic spray coating assembly. The input end is connected to the ultrasonic converter and the output end produces the spray.

FIG. 3 illustrates the surface wave system that exists on the surface of the spray forming tip of the ultrasonic spray coating assembly. The surface wave system consists of surface wave on the feed blade surface and a compression wave on the atomizing surface of the spray forming tip.

FIG. 4 illustrates the liquid film that forms on the spray forming tip as the liquid exits the liquid applicator of the ultrasonic spray coating assembly.

FIG. 5 illustrates an ideal depiction of the spray produced by the ultrasonic energy of the ultrasonic spray coating assembly. The spray should be produced in a uniform, “sheet-like” pattern as it is propelled from the spray forming tip.

FIG. 6 illustrates the positive displacement pump for delivering the coating liquid to the spray head.

FIG. 7 illustrates the prior art gas director relative to the spray forming tip.

FIG. 8 illustrates the improved gas applicator relative to the spray forming tip.

FIG. 9 illustrates the air flow path into and out of the gas applicator.

FIG. 10 illustrates the internal passageway of the gas applicator.

FIG. 11 illustrates the air flow path from the exit of the gas applicator to the surface of the spray forming tip of the ultrasonic head.

### DETAILED DESCRIPTION OF THE INVENTION

As illustrated in the Figures accompanying this specification, the ultrasonic spray coating system comprises of an ultrasonic spray head assembly and an ultrasonic power generator.

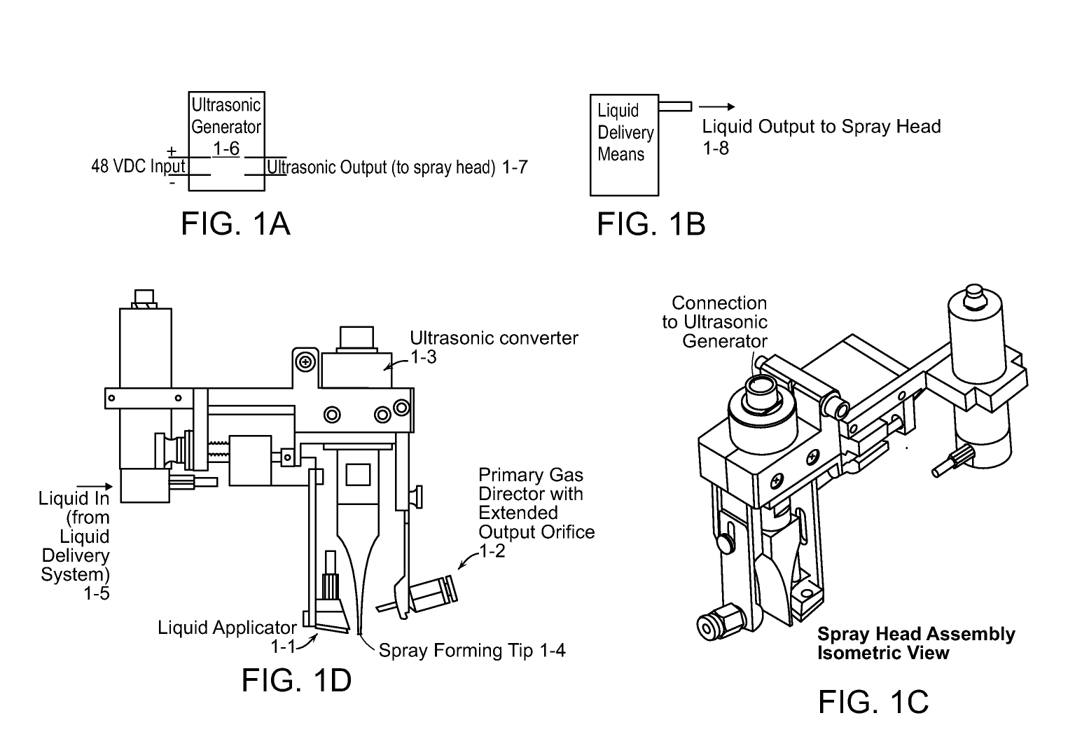

As shown in FIG. 1, the ultrasonic spray coating system includes the following components, namely:

1-1 Liquid Applicator

1-2 Primary Gas Director

1-3 Ultrasonic Converter

1-4 Spray Forming Tip

1-5 Liquid In Port

1-6 Ultrasonic Generator

1-7 Ultrasonic Output to Spray Head

1-8 Liquid Delivery Output to Spray head

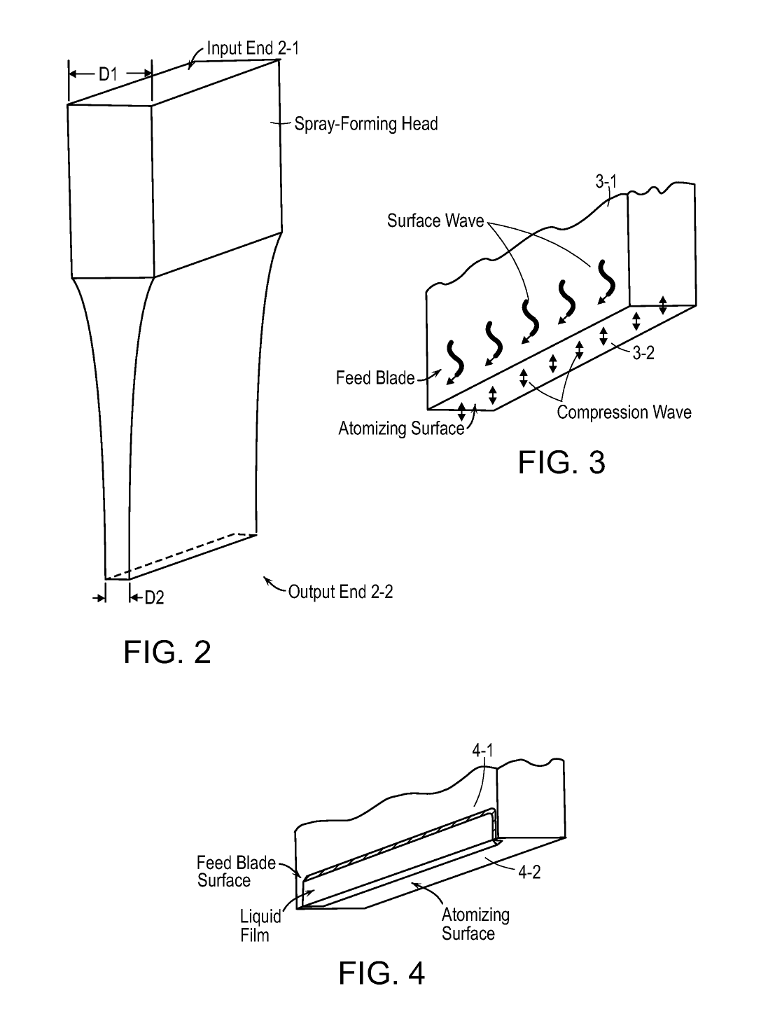

As shown in FIG. 2, the spray forming head part of the ultrasonic spray coating assembly includes the following components, namely:

2-1 Input End

2-2 Output End

As shown in FIG. 3, a surface wave system exists on the surface of the spray forming tip of the ultrasonic spray coating assembly. The surface wave system includes the following components, namely:

3-1 Feed Blade with Surface Wave

3-2 Atomizing Surface with Compression Wave

As shown in FIG. 4, a liquid film forms on the spray forming tip as the liquid exits the liquid applicator of the ultrasonic spray coating assembly. This figure illustrates the following components:

4-1 Feed Blade with Liquid Film

4-2 Atomizing Surface with Liquid Film

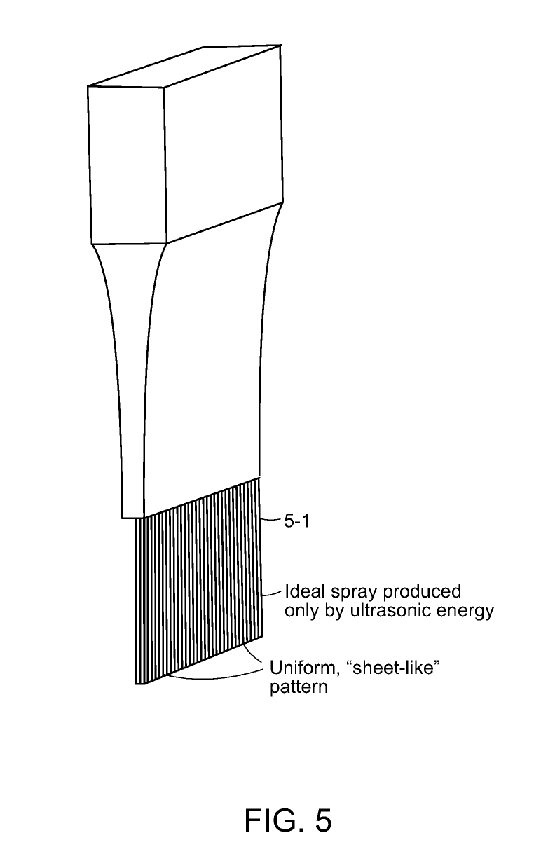

As shown in FIG. 5, an ideal depiction of the spray produced by the ultrasonic energy of the ultrasonic spray coating assembly is illustrated. The spray is produced in a uniform, “sheet-like” pattern as it is propelled from the spray forming tip. This figure illustrates the following components:

5-1 Ideal Uniform, “sheet-like” Spray Pattern

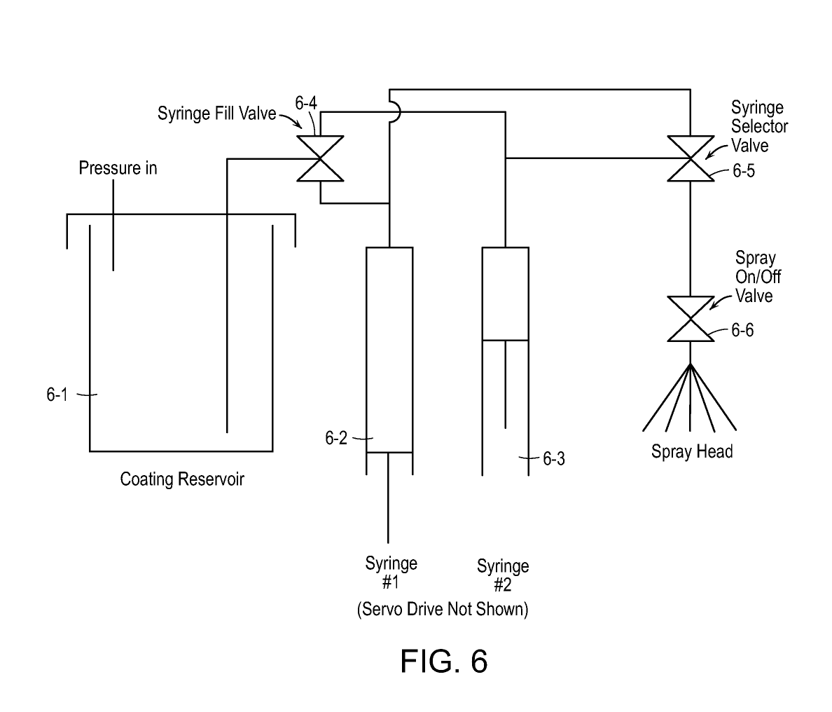

As shown in FIG. 6, a positive displacement pump is employed for delivering the coating liquid to the spray head. This figure illustrates the following components:

6-1 Coating Reservoir

6-2 Syringe Pump #1

6-3 Syringe Pump #2

6-4 Syringe Fill Valve

6-5 Syringe Selector Valve

6-6 Spray On/Off Valve

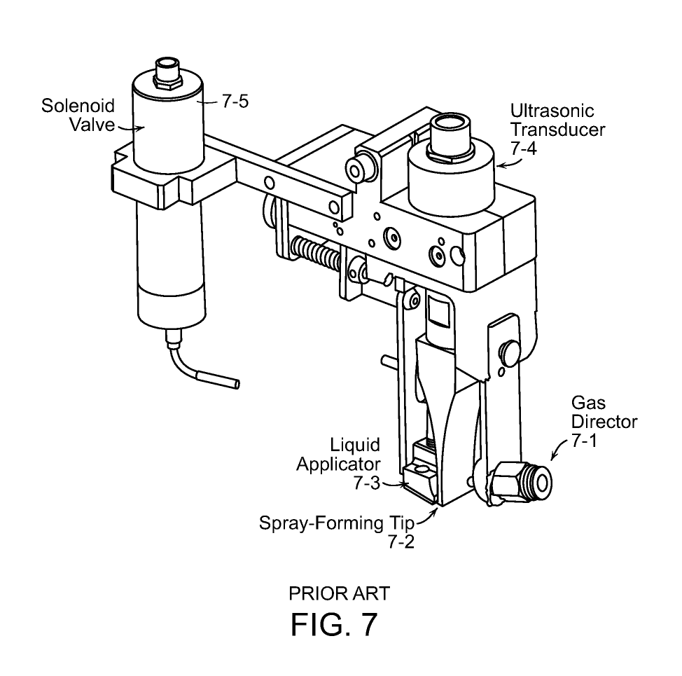

As shown in FIG. 7, a prior art gas director is located relative to the spray forming tip. This figure illustrates the following components:

7-1 Prior Art Gas Director

7-2 Spray Forming Tip

7-3 Liquid Applicator

7-4 Ultrasonic Transducer

7-5 Spray On/Off Valve (solenoid)

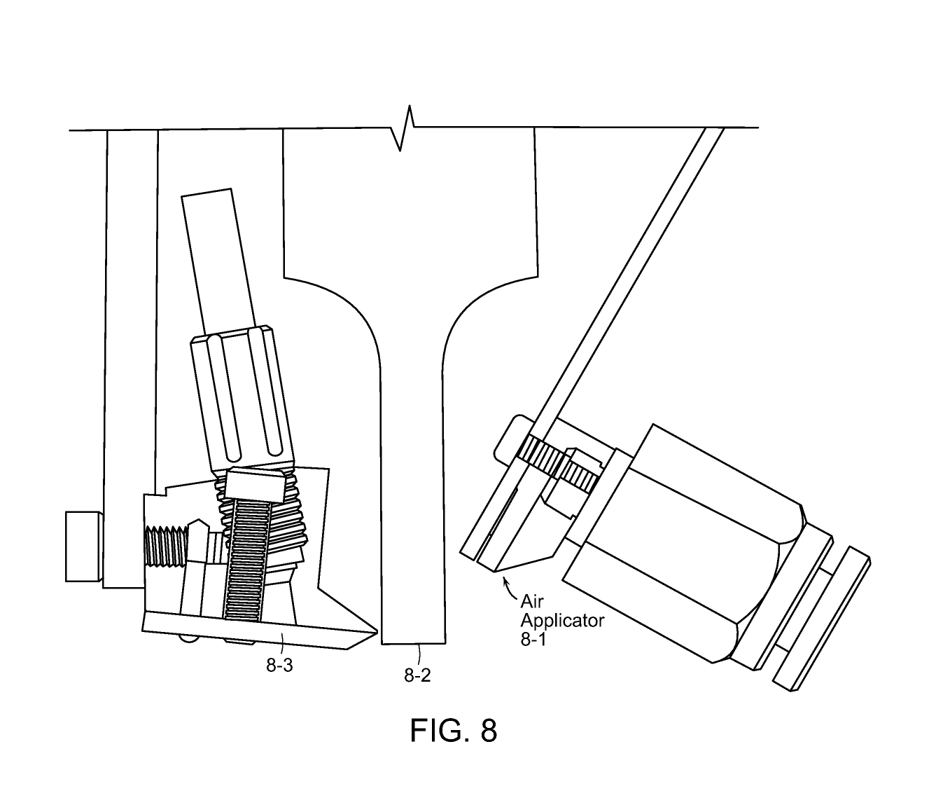

As shown in FIG. 8, the improved gas applicator of the present invention is located relative to the spray forming tip. This figure illustrates the following components:

8-1 Air Applicator

8-2 Spray Forming Tip

8-3 Liquid Applicator

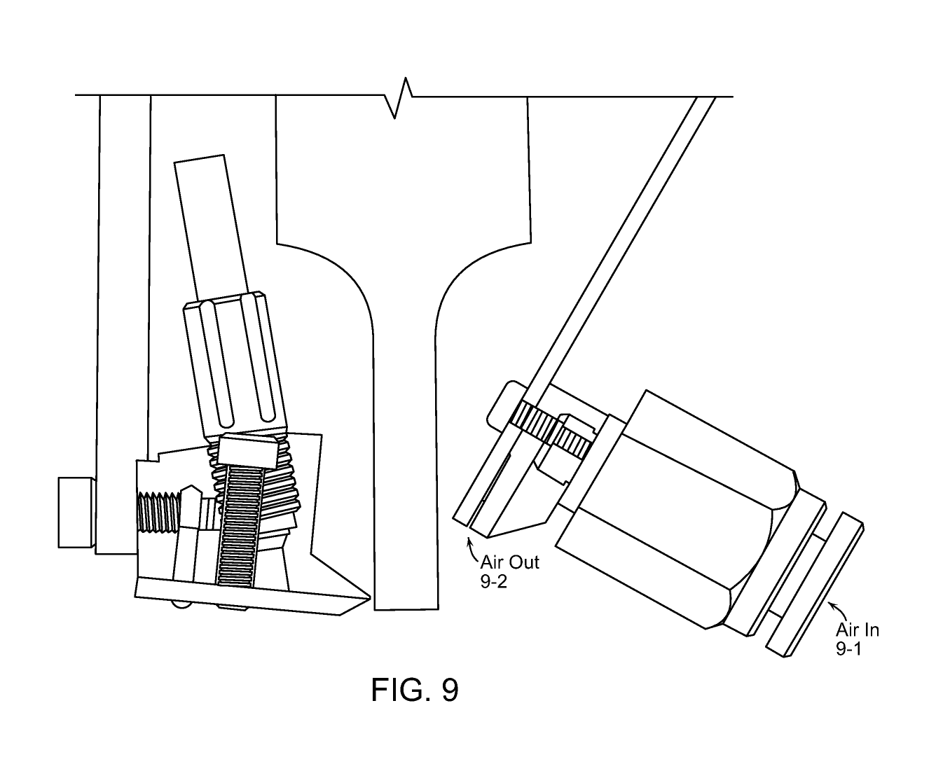

As shown in FIG. 9, the air flow path into and out of the gas applicator is provided. This figure illustrates the following components:

9-1 Air In Port

9-2 Air Out Port

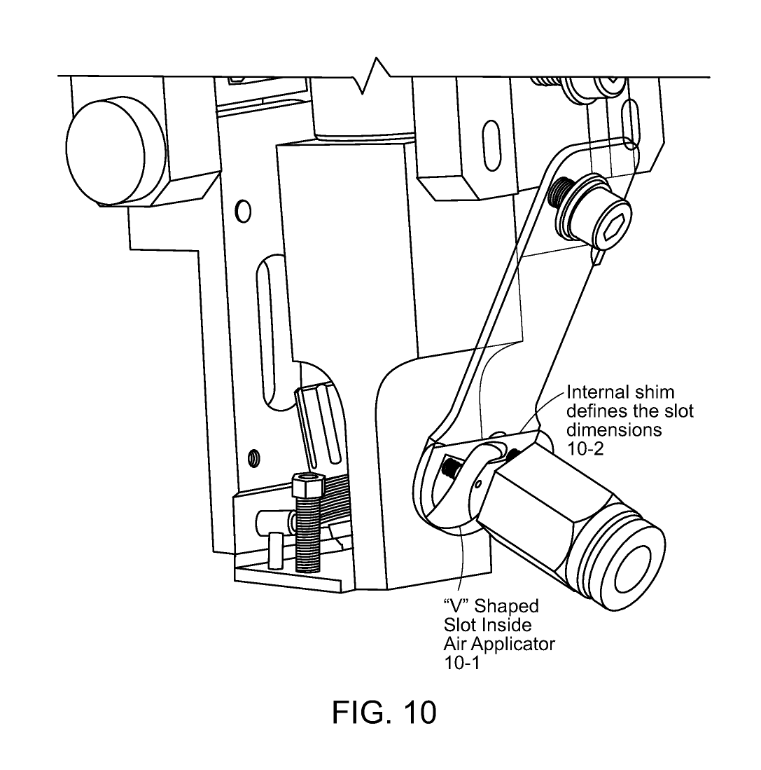

As shown in FIG. 10, the internal passageway of the gas applicator are provided. This figure illustrates the following components:

10-1 “V” Shaped Slot Inside Air Applicator

10-2 Internal Shim to Define Slot Dimensions

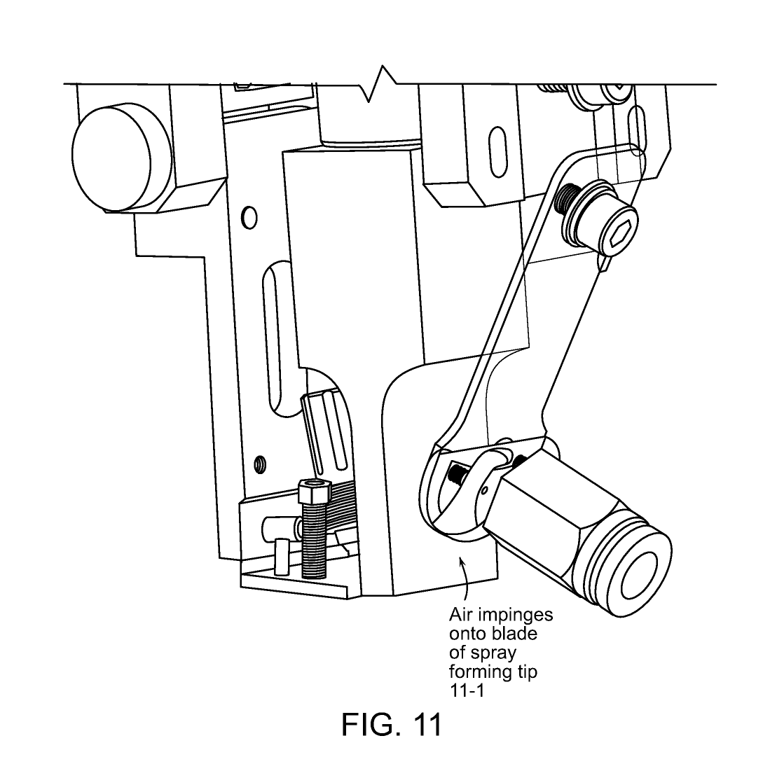

As shown in FIG. 11, the air flow path from the exit of the gas applicator to the surface of the spray forming tip of the ultrasonic head is provided. This figure illustrates the following components:

11-1 Air Impingement Point from Air Applicator to Blade

As shown in the Figures, the present invention comprises an ultrasonic spray coating system having a converter mechanism for converting high frequency electrical energy into high frequency mechanical energy to thereby produce vibrations. The converter mechanism is designed to have one resonant frequency. A spray forming head is coupled to the converter mechanism and is resonant at the same resonant frequency. The spray forming head has a spray forming tip and concentrates the vibrations of the converter at the spray forming tip. The spray forming tip has a feed blade and an atomizing surface. The spray forming tip concentrates a surface wave on the feed blade and a compression wave on the atomizing surface from the vibrations of the converter. A high frequency alternating mechanism is electrically connected to the converter mechanism to produce a controllable level of electrical energy at the proper operating frequency of the spray forming head/converter mechanism such that the spray forming tip is vibrated ultrasonically with a surface wave concentrated on the feed blade and a displacement wave concentrated on the atomizing surface.

A liquid supplier is provided having a liquid applicator in close proximity with the feed blade of the spray forming tip and spaced therefrom. The liquid applicator includes an output surface having an orifice therein. The output surface is in close proximity with the feed blade of the spray forming tip and spaced therefrom. The output surface of the liquid applicator and feed blade of the spray forming tip are at substantially right angles to each other such that the liquid supplied from the liquid applicator forms a bead or meniscus between the output orifice of the liquid applicator and the feed blade of the spray forming tip. The meniscus is formed and sustained by the flow of liquid from the output orifice of the liquid applicator and the ultrasonic surface wave that exists on the feed blade of the spray forming tip. The ultrasonic surface wave enables the liquid to “wet-out” and adhere to the feed blade of the spray forming tip. The surface tension of the liquid allows the meniscus to form and constant flow of liquid sustains the meniscus. The longitudinal displacement wave (that displaces the atomizing surface) pumps the liquid from the feed blade to the atomizing surface. A film of liquid then forms on the atomizing surface and is transformed into small drops and propelled from the atomizing surface in the form of a rectilinear spray. Finally, a controllable gas entrainment mechanism is associated with the spray forming head for affecting and controlling the velocity and pattern of the resultant spray.

Improvements to the gas entrainment mechanism of the ultrasonic spray coating system are presented herein.

### Spray Forming Head Description

Referring in detail to FIG. 2, the ultrasonic spray forming head is comprised of an input end, a body and a spray forming tip. The spray forming tip or output end contains a feed blade and an atomizing surface. The spray head has a resonant frequency (fₛₕ) and has a length equal to one-half wavelength (λ/2) of the resonant frequency. The wavelength for a particular spray head is defined by:

λ=Cₘ/fₛₕ

### Where:

λ=Wavelength (inches)
Cₘ=material's speed of sound (inches/second)
fₛₕ=resonant frequency (Hertz or 1 cycle/second)

The practical resonant frequencies range from 20 kHz to 120 kHz for atomizing liquids (20 kHz≧fsh≦120 kHz). The spray head is constructed of metal, either 6A1-4V titanium or 7075-T6 aluminum; titanium is preferred because of its strength and corrosion resistance properties.

The input end is comprised of a coupling surface and a coupling screw. The input end of the spray head is connected to an ultrasonic converter. The input must be flat and smooth for optimal mechanical coupling to the converter. The ultrasonic converter has a resonant frequency (f_{c}) that is matched to the resonant frequency of the spray head (fₛₕ) or f_{c}=fₛₕ.

The body connects the input end to the output end and is formed to concentrate ultrasonic vibrations on the output end. To achieve ultrasonic amplification through the body, the input end must be larger than the output end. The profile of the body can be stepped, linear, exponential or Catenoid. The Catenoid shape is preferred because it provides the largest amplification of the sound wave through the body to the output end, which in turn, provides maximum atomizing capability. Preferable ratios of output end dimension “D” (D₂) to input end diameter (D₁) are:

4≧(D₁/D₂)≦8

The Catenoid shape is described by the catenoidal equation:

Y=Yₒ*cos h[m(X−X₀)]

Where: X→X coordinate

Y→Y coordinate at X

X₀→X coordinate of the lowest point on Catenoid

Y₀→Y coordinate of the lowers point on Catenoid

Cos h→hyperbolic cosine

M→Constant (depends on the end points of the Catenoid)

Referring to the detail in FIG. 3, the spray forming tip has two main features: 1) an atomizing surface that provides concentrated ultrasonic vibrations with sufficient energy to atomize a flowing liquid, 2) a feed blade that causes a liquid that is applied to it to flow to the atomizing surface. The feed blade surface and the atomizing surface are at substantially right angles to each other.

The purpose of the feed blade is to direct all of the liquid flow from the liquid applicator towards and onto the atomizing surface. The wave system that exists on the feed blade and the atomizing surface of the spray-forming tip is described in detail in the prior art patents referenced above. The wave system, as shown in FIG. 3, consists of a surface wave on the feed blade and a compression wave on the atomizing surface. The surface wave causes the liquid to form a film on the feed blade and then pumps the liquid from the feed blade, over the right-angle edge, to the atomizing surface of the spray-forming tip.

To produce a uniform spray pattern from the spray-forming tip, it is essential that 1) the liquid is delivered uniformly to the feed blade across its width by the liquid applicator and 2) that the liquid is delivered uniformly from the feed blade to the atomizing surface across its width. These two conditions ensure that a liquid film (FIG. 4) of uniform thickness is first formed on the feed blade and then pumped to the atomizing surface of the spray-forming tip where it is instantaneously broken up into small drops by the energy of the ultrasonic compression wave.

The “liquid film” shown in FIG. 4 is part of the meniscus that forms between the output orifice of the liquid applicator and the feed blade of the spray forming tip. The “liquid film” is the section of the liquid meniscus that contacts the feed blade and is of the same thickness as the film that forms on the atomizing surface of the spray forming tip. FIG. 4 shows a liquid film being transferred from the feed blade to the atomizing surface of the spray-forming tip; this is for illustrative purposes only since the film is immediately “atomized” at the leading edge of the atomizing surface. Once the liquid is broken up into small drops, the drops are propelled then from the tip in the form of a spray. The size of the drops produced by compression wave is directly proportional to the thickness of the liquid film that is delivered to the atomizing surface from the feed blade. The drop size variation is also directly proportional to the liquid film thickness variation delivered to the atomizing surface. Also, the contiguity of the stream of drops being propelled from the atomizing surface is directly related to the contiguity of the liquid film that is delivered to aforementioned atomizing surface. The size of the drops, the drop size distribution, and the contiguity of the spray pattern and the shape of the spray pattern define the “quality” of the spray pattern.

Therefore, the quality of the spray pattern is directly related to the uniformity of the liquid film that is delivered to the atomizing surface by the pumping action of the feed blade from the meniscus of liquid that is formed between the liquid applicator and the feed blade. Additionally, the coating deposition on the substrate is directly related to the quality of the spray pattern. A uniform spray pattern will produce a uniform coating deposition on the substrate to be coated.

This pumping action of the feed blade wave system is effective in causing the liquid to form a uniform film on the surface of the feed blade and delivering the uniform liquid film from the liquid applicator to the atomizing surface of the spray-forming tip, within certain operating parameters, such as the flow rate and surface tension for a particular liquid. When the liquid flow rate and liquid surface tension are within certain limits, a very uniform, “sheet-like”, spray is produced by the spray-forming tip, as can be seen in FIG. 5.

The liquid is fed to the liquid applicator with a “positive displacement” pump, for example a syringe pump, to ensure that the passageways in the liquid applicator do not influence the liquid flow rate. The positive displacement pump ensures that the liquid is supplied to the spray head at a precise flow rate independent of the associated resistances of the liquid lines, fittings, etc. Referring to the detail in FIG. 6, the positive displacement pump is designed with a dual piston system and liquid storage reservoir so that the flow of liquid to the spray head is not interrupted when one of the syringes is empty.

The gas applicator is used to expand and shape the spray generated by the spray forming tip of the spray head. As illustrated in FIGS. 8 through 11, the improvement in the gas entrainment system is the development of a gas applicator. The gas applicator impinges a curtain of air onto the surface of the spray head tip producing a uniform expanding air flow without pulsations. The air curtain impinges off the surface of the spray forming tip entraining the ultrasonically produces spray and uniformly expanding the spray pattern width.

FIG. 8 shows the relationship of the air applicator with the surface of the spray forming tip.

FIG. 9 shows the flow path into and out of the gas applicator; the air enters the gas applicator through the input orifice and its flow is converted from a “tube flow” to a “slot flow” pattern.

FIG. 10 shows the internal “v” shaped slot inside the gas applicator. The exact dimensions of the slot are determined by the size of a shim used to form the slot. The dimensions of the slot can be changed to optimize the resulting air flow pattern for specific coating materials and conditions. The thickness of the shim and the angle that forms the internal “v” passageway can be adjusted as required.

FIG. 11 shows the impingement point of the air-stream from the gas applicator onto the spray forming tip of the spray head. The exact impingement point and impingement angle can be adjusted to optimize the resulting air flow pattern to suit a particular coating liquid and coating deposition requirements.

The gas applicator expands the ultrasonically produced spray uniformly and without pulsations. This improvement enable a given coating to be applied more uniformly than prior art.

### Ultrasonic Generator Description

The ultrasonic power generator drives the ultrasonic spray head. A voltage generator drives the spray head at the proper operating frequency. The circuitry is designed to include the spray head in the frequency control path and to adjust power according to system demand. The operating frequency (f₀) generated is between the resonant frequency (fᵣ) and the anti-resonant frequency (fₐ) of the spray head, such that a proper ultrasonic wave system is established in the spray forming tip. The principle of operation of the ultrasonic generator and the resulting wave system in the spray forming tip is described in the above referenced prior art patents. The ultrasonic generator is designed to generate and maintain the required operating frequency during changing environments such as ambient temperature. Additionally, the amplitude of the ultrasonic output from the generator is adjustable to accommodate the flow rate requirements of various situations.

The power generator features a unique full bridge power output circuit configuration with a frequency driven pulse mode driver. The high frequency alternating voltage generator utilizes MOSFET power transistors in a bridge type, transformer-coupled configuration (not shown) to provide power to the ultrasonic converter. The DC supply voltage to the bridge circuit is varied to control the level of voltage delivered to the ultrasonic converter.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. An ultrasonic spray coating system comprising:
a converter for converting high frequency electrical energy into high frequency mechanical energy to thereby produce vibrations,
a spray forming head coupled to said converter, said spray forming head having 1a narrowed spray forming tip with substantially planar opposing side surfaces, the spray forming tip terminating at a substantially planar atomizing surface, one of the side surfaces comprising a feed blade being substantially perpendicular to the atomizing surface;
a high frequency alternating generator electrically connected to said converter for producing a controllable level and frequency of electrical energy at an operating frequency of said spray forming head and converter wherein the atomizing surface is uniformly displaced in a normal direction by the vibrations and wherein a surface wave component is induced in the first region along the feed blade, the surface wave component being in a direction toward the atomizing surface;
a liquid applicator in close proximity with the first region of said feed blade and spaced therefrom, said liquid supply applicator having an output surface including an orifice therein, such that liquid supplied from the output orifice to the feed blade is caused to flow to and on said atomizing surface under the influence of said surface wave component and said liquid is atomized by the displacement of said atomizing surface and is thereby changed to a spray; and
a controllable gas entrainment mechanism associated with said spray forming head, the gas entrainment mechanism including a primary gas director for directing a first stream of gas at a region of the side surface of the spray forming tip opposite said feed blade, an angle measured between the first stream of gas and the side surface opposite said feed blade being less than 90° such that the first stream of gas impinges off the region thereby forming a fan-shaped air pattern in a direction substantially normal to the atomizing surface for affecting and controlling said spray.

2. The ultrasonic spray coating system of claim 1, wherein the surface feed blade is modified to include a series of shallow channels to redirect and concentrate the surface wave component that exists on this surface, such that the surface wave has directional components in the x, y and z planes.

3. The ultrasonic spray coating system of claim 1, wherein the inside orifice of the liquid supply applicator is modified to form a series of liquid guide channels to form a liquid flow guide.

4. The ultrasonic spray coating system of claim 1, wherein the output orifice of the primary gas director is extended to bring the output orifice closer to the impingement surface of the spray forming head.

5. The ultrasonic spray coating system of claim 3, wherein a positive displacement pump is utilized to deliver liquid to the spray forming tip at a precise flow rate independent of the associated resistance to flow created by the liquid guide channels inside the liquid supply applicator.

6. The ultrasonic spray coating system of claim 2, wherein the surface wave with three (3) directional components redirects the liquid flow over the surface of the feed blade to form a film with a more uniform thickness.

7. The ultrasonic spray coating system of claim 2, wherein the surface wave with three (3) directional components pumps the more uniform liquid film to the atomizing surface of the spray forming tip producing a spray containing drops with a smaller median drop size.

8. The ultrasonic spray coating system of claim 2, wherein the surface wave with three (3) directional components pumps the more uniform liquid film to the atomizing surface of the spray forming tip producing a spray containing drops with a more uniform drop size distribution.

9. The ultrasonic spray coating system of claim 4, wherein the extended output orifice of the primary gas director enables the ultrasonically produced spray to be expanded to a greater expanded width by more than a factor of 2.

10. The ultrasonic spray coating system of claims 2 and 3, wherein the combination of the modified feed blade surface and the modified liquid supply applicator orifice enables a uniform spray to be produced by the spray forming tip at a substantially lower flow rate.

11. The ultrasonic spray coating system of claims 2, 3 and 4, wherein the combination of the modified feed blade surface, the modified liquid supply applicator orifice.

12. A gas applicator for use in the ultrasonic spray coating system of claims 2, 3 and 4, wherein the gas is forced through a precision machined applicator tip comprising a curved slot at the output orifice.

13. The gas applicator of claim 12, wherein the gas flows out of the applicator orifice at a controlled velocity in an expanding fan pattern.

14. The gas applicator of claim 13, wherein the gas comprises air.

15. The gas applicator of claim 14, wherein the air stream is directed to impinge on to the spray forming tip of the ultrasonic spray coating assembly.

16. The gas applicator of claim 15, wherein the directed air stream is then re-directed as it impinges on to the spray forming tip, whereby the resulting air stream entrains the ultrasonically produced spray and expands the spray width without creating pulsations.
